(19) United States
(12) Patent Application Publication
(10) Pub. No.: US 2024/0032026 A1
(43) Pub. Date: Jan. 25, 2024

(54) MULTIPLEXING OF OVERLAPPED UPLINK CHANNEL TRANSMISSION REPETITIONS

(71) Applicant: QUALCOMM Incorporated, San Diego, CA (US)

(72) Inventors: Yan ZHOU, San Diego, CA (US); Tianyang BAI, Somerville, NJ (US); Konstantinos DIMOU, New York, NY (US); Yi HUANG, San Diego, CA (US); Ahmed ELSHAFIE, San Diego, CA (US); Jing SUN, San Diego, CA (US); Seyedkianoush HOSSEINI, San Diego, CA (US); Tao LUO, San Diego, CA (US)

(21) Appl. No.: 18/043,261

(22) PCT Filed: Oct. 25, 2021
(86) PCT No.: PCT/US2021/072021

§ 371 Date: Feb. 27, 2023

(30) Foreign Application Priority Data
Oct. 27, 2020 (GR) 20200100649

(51) Int. Cl. H04W 72/1268; H04L 1/08; H04W 72/56

(52) U.S. Cl. CPC H04W 72/1268; H04L 1/08; H04W 72/56

(57) ABSTRACT

Apparatus, methods, and computer-readable media for multiplexing of overlapped uplink channel transmission repetitions are disclosed herein. A user equipment (UE) may determine that at least a portion of a first set of uplink channel transmission repetitions overlaps with at least a portion of a second set of uplink channel transmission repetitions. The UE may modify the first set of uplink channel transmission repetitions based on the second set of uplink channel transmission repetitions. A base station (BS) may transmit a first downlink transmission associated with the first set of uplink channel transmission repetitions that overlaps with at least a portion of a second set of uplink channel transmission repetitions associated with a second downlink transmission. The BS may receive a modified version of the first set of uplink channel transmission repetitions based on the second set of uplink channel transmission repetitions. Thus, the reliability of uplink repetitions can be increased.

### CROSS REFERENCE TO RELATED APPLICATION(S)

This application claims the benefit of Greece Patent Application Serial No. 20200100649, entitled “MULTIPLEXING OF OVERLAPPED UPLINK CHANNEL TRANSMISSION REPETITIONS” and filed on Oct. 27, 2020, which is expressly incorporated by reference herein in its entirety.

### BACKGROUND

### Technical Field

The present disclosure relates generally to wireless communication, and more particularly, to techniques for multiplexing of overlapped uplink channel transmission repetitions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In uplink repetitions, two PUCCH sequences may overlap with one another over at least one slot (e.g., in a slot-based procedure). In some approaches of facilitating uplink repetitions, a priority may be assigned to each uplink repetition. In some aspects, if both uplink repetitions with different priorities overlap with one another, the repetition with the lower priority is dropped. For example, the uplink repetition with the lower priority may be dropped after a first overlapping symbol within a slot. In other aspects, if both uplink repetitions have the same priority, one of the overlapping repetitions may be dropped based on its content. In some examples, if one uplink repetition carries HARQ-ACK information and the other uplink repetition carries SR information, the uplink repetition containing the SR is dropped. In other examples, if both uplink repetitions carry HARQ-ACK information, the later slotted uplink repetition is dropped.

As described above, when two uplink repetitions with different priorities overlap with one another, the lower priority uplink repetition is dropped. However, this approach in handling overlapping uplink repetitions with different priorities requires additional resources to retransmit downlink data when a dropped uplink repetition carries HARQ-ACK information.

The subject technology provides for multiplexing uplink control information (UCI)/uplink (UL) channels with different priorities. In some aspects, low priority (LP)/high priority (HP) hybrid automatic repeat request-acknowledgment (HARQ-ACK) can be multiplexed with HP/LP HARQ-ACK and/or scheduling request (SR), respectively. In some aspects, LP/HP or both LP+HP HARQ-ACK can be multiplexed with HP/LP physical uplink shared channel (PUSCH), respectively.

The subject technology may support multiplexing for a number of scenarios in 5G NR technologies including, but not limited to: (1) multiplexing a high-priority HARQ-ACK and a low-priority HARQ-ACK into a physical uplink control channel (PUCCH); (2) multiplexing a low-priority HARQ-ACK and a high-priority SR into a PUCCH for one or more HARQ-ACK/SR PF combinations (FFS applicable combinations); (3) multiplexing a low-priority HARQ-ACK, a high-priority HARQ-ACK and a high-priority SR into a PUCCH; (4) multiplexing a low-priority HARQ-ACK in a high-priority PUSCH (conveying UL-SCH only); (5) multiplexing a high-priority HARQ-ACK in a low-priority PUSCH (conveying UL-SCH only); (6) multiplexing a low-priority HARQ-ACK, a high-priority PUSCH conveying UL-SCH, a high-priority HARQ-ACK and/or channel state information (CSI); and (7) multiplexing a high-priority HARQ-ACK, a low-priority PUSCH conveying UL-SCH, a low-priority HARQ-ACK and/or CSI.

In this regard, the subject technology increases the efficiency and reliability of uplink repetition transmissions by facilitating the multiplexing of overlapped uplink repetitions with different priorities, including low priority uplink repetitions carrying HARQ-ACK information.

In an aspect of the disclosure, a method, a computer-readable medium, and an apparatus are provided. The apparatus may be a UE. The apparatus is configured to determine that at least a portion of a first set of uplink channel transmission repetitions overlaps with at least a portion of a second set of uplink channel transmission repetitions. The apparatus is also configured to modify the at least a portion of the first set of uplink channel transmission repetitions based on the at least a portion of the first set of uplink channel transmission repetitions overlapping with the at least a portion of the second set of uplink channel transmission repetitions.

In an aspect of the disclosure, a method, a computer-readable medium, and an apparatus are provided. The apparatus may be a base station. The apparatus is configured to transmit, to a UE over a downlink channel, a first downlink transmission associated with a first set of uplink channel transmission repetitions, wherein at least a portion of the first set of uplink channel transmission repetitions overlaps with at least a portion of a second set of uplink channel transmission repetitions associated with a second downlink transmission. The apparatus is also configured to receive, from the UE over an uplink channel, a modified version of the first set of uplink channel transmission repetitions based on the at least a portion of the first set of uplink channel transmission repetitions overlapping with the at least a portion of the second set of uplink channel transmission repetitions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a diagram illustrating an example of multiplexed uplink channel transmission repetitions, in accordance with some aspects of the present disclosure.

FIG. 5 is a diagram illustrating another example of multiplexed uplink channel transmission repetitions, in accordance with some aspects of the present disclosure.

FIG. 6 is a diagram illustrating an example of shifted uplink channel transmission repetitions, in accordance with some aspects of the present disclosure.

FIG. 7 is a flowchart of a process of wireless communication for multiplexing of overlapped uplink channel transmission repetitions at a user equipment, in accordance with some aspects of the present disclosure.

FIG. 8 is a flowchart of a process of wireless communication for multiplexing of overlapped uplink channel transmission repetitions at a user equipment, in accordance with some aspects of the present disclosure.

FIG. 9 is a flowchart of a process of wireless communication for multiplexing of overlapped uplink channel transmission repetitions at a user equipment, in accordance with some aspects of the present disclosure.

FIG. 10 is a flowchart of a process of wireless communication for multiplexing of overlapped uplink channel transmission repetitions at a base station, in accordance with some aspects of the present disclosure.

FIG. 11 is a diagram illustrating an example of a hardware implementation for an example apparatus.

FIG. 12 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

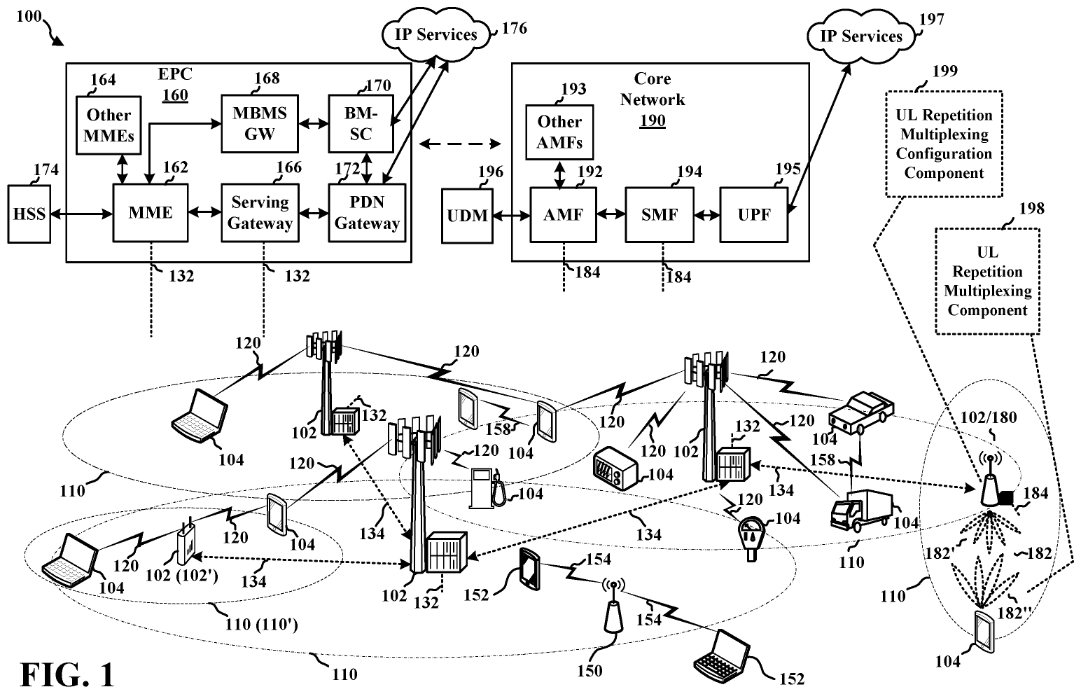

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., 51 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Frequency range bands include frequency range 1 (FR1), which includes frequency bands below 7.225 GHz, and frequency range 2 (FR2), which includes frequency bands above 24.250 GHz. Communications using the mmW/near mmW radio frequency (RF) band (e.g., 3 GHz-300 GHz) has extremely high path loss and a short range. Base stations/UEs may operate within one or more frequency range bands. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include an uplink repetition multiplexing component 198 that is configured to determine whether a first subset of a first set of uplink channel transmission repetitions overlaps with at least a portion of a downlink transmission. The uplink repetition multiplexing component 198 is also configured to determine whether to transmit a second subset of the first set of uplink channel transmission repetitions when the first subset overlaps with the at least a portion of the downlink transmission, in which the second subset includes one or more uplink channel transmission repetitions that do not overlap with the downlink transmission. The uplink repetition multiplexing component 198 is also configured to transmit, to a base station over an uplink channel, a second set of uplink channel transmission repetitions comprising the first subset and the second subset of the first set of uplink channel transmission repetitions when the second subset is determined to be transmitted, in which the second set of uplink channel transmission repetitions does not overlap with the downlink transmission

Referring still to FIG. 1, in certain aspects, the base station 102/180 may include an uplink repetition multiplexing configuration component 199 that is configured to transmit, to a user equipment (UE) over a downlink channel, a first downlink transmission comprising a configuration indicating a request to retransmit a first subset of a first set of uplink channel transmission repetitions that overlaps with at least a portion of a second downlink transmission. The uplink repetition multiplexing configuration component 199 is also configured to receive, from the UE over an uplink channel, a second set of uplink channel transmission repetitions comprising the first subset of the first set of uplink channel transmission repetitions and a second subset of the first set of uplink channel transmission repetitions, the second subset comprising one or more uplink channel transmission repetitions that do not overlap with the second downlink transmission, in which the second set of uplink channel transmission repetitions does not overlap with the second downlink transmission.

Although the following description may be focused on 5G NR, the concepts described herein may be applicable to other similar areas, such as LTE, LTE-A, CDMA, GSM, and other wireless technologies.

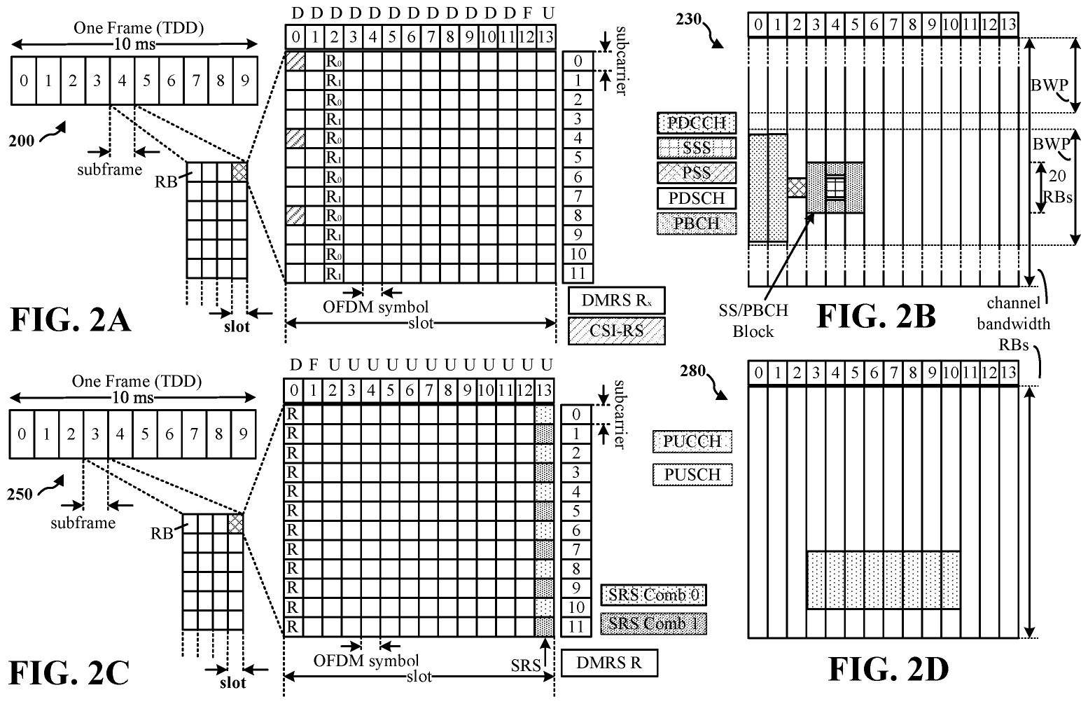

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIGs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) ACK/NACK feedback. The PUSCH carries data, and may additionally be used to carry a buffer status report (BSR), a power headroom report (PHR), and/or UCI.

The present disclosure provides for the multiplexing of UCI/uplink (UL) channels with different priorities. In some aspects, LP/HP HARQ-ACK can be multiplexed with HP/LP HARQ-ACK and/or SR, respectively. In some aspects, LP/HP or both LP+HP HARQ-ACK can be multiplexed with HP/LP PUSCH, respectively. The subject technology may support multiplexing for a number of scenarios in 5G NR technologies including, but not limited to: (1) multiplexing a high-priority HARQ-ACK and a low-priority HARQ-ACK into a PUCCH; (2) multiplexing a low-priority HARQ-ACK and a high-priority SR into a PUCCH for one or more HARQ-ACK/SR PF combinations (FFS applicable combinations); (3) multiplexing a low-priority HARQ-ACK, a high-priority HARQ-ACK and a high-priority SR into a PUCCH; (4) multiplexing a low-priority HARQ-ACK in a high-priority PUSCH (conveying UL-SCH only); (5) multiplexing a high-priority HARQ-ACK in a low-priority PUSCH (conveying UL-SCH only); (6) multiplexing a low-priority HARQ-ACK, a high-priority PUSCH conveying UL-SCH, a high-priority HARQ-ACK and/or CSI; and (7) multiplexing a high-priority HARQ-ACK, a low-priority PUSCH conveying UL-SCH, a low-priority HARQ-ACK and/or CSI. In this regard, the subject technology increases the efficiency and reliability of uplink repetition transmissions by facilitating the multiplexing of overlapped uplink repetitions with different priorities, including low priority uplink repetitions carrying HARQ-ACK information.

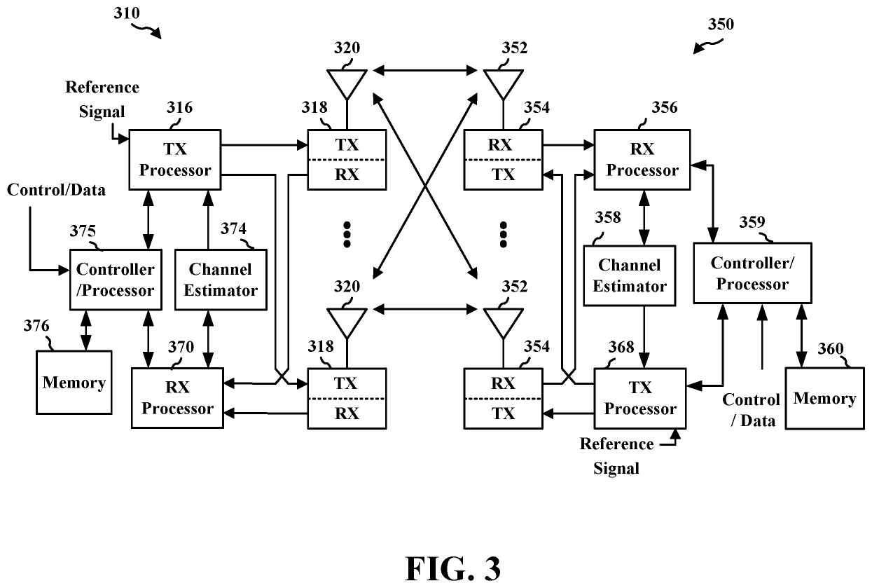

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIGs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

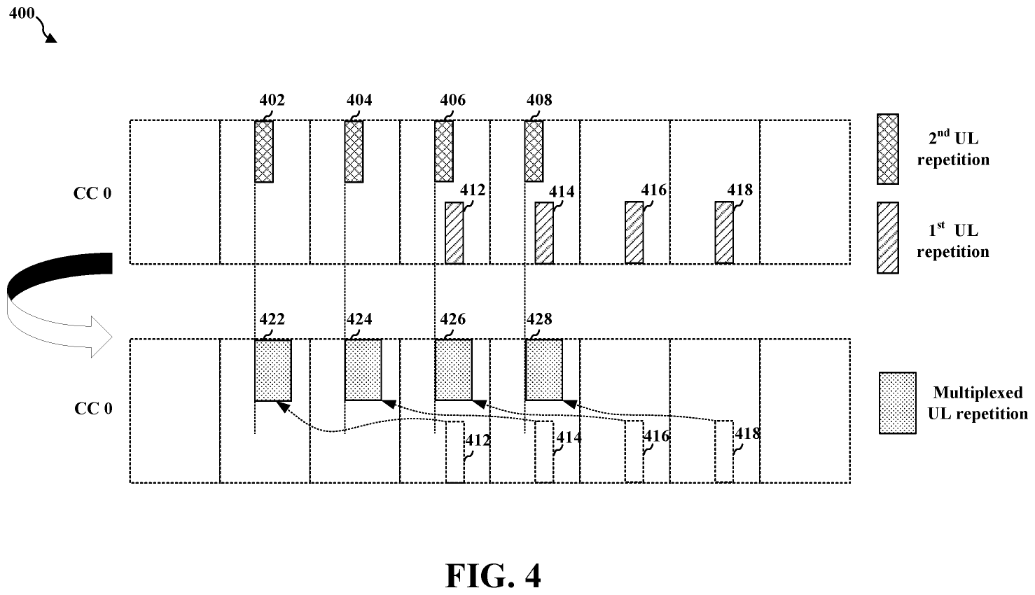

FIG. 4 is a diagram illustrating an example 400 of multiplexed uplink channel transmission repetitions, in accordance with some aspects of the present disclosure. The example 400 includes a first set of uplink channel transmission repetitions (e.g., 412, 414, 416, 418) and a second set of uplink channel transmission repetitions (e.g., 402, 404, 406, 408). As illustrated in FIG. 4, the user equipment may determine that uplink channel transmission repetitions 412 and 414 overlaps with the uplink channel transmission repetitions 406 and 408, respectively. In some aspects, the overlapping may occur on one or more symbols within a slot. For example, the uplink channel transmission repetition 412 may overlap the uplink channel transmission repetition 406 by at least one symbol. In this regard, the overlapping of the uplink repetitions may cause an increase in resource utilization to retransmit the overlapped uplink repetitions at a later time. To increase the transmission efficiency of uplink repetitions, the overlapped uplink repetitions can be multiplexed into the other uplink repetition sequence.

The user equipment may modify the uplink channel transmission repetitions 412-418 based on the second set of uplink channel transmission repetitions. In various aspects, the user equipment can modify the uplink channel transmission repetitions 412-418 by multiplexing the uplink channel transmission repetitions 412-418 respectively into the uplink channel transmission repetitions 402-408 to form a set of multiplexed uplink repetitions 422, 424, 426, 428. Consequently, the uplink channel transmission repetitions 412-418 may be dropped.

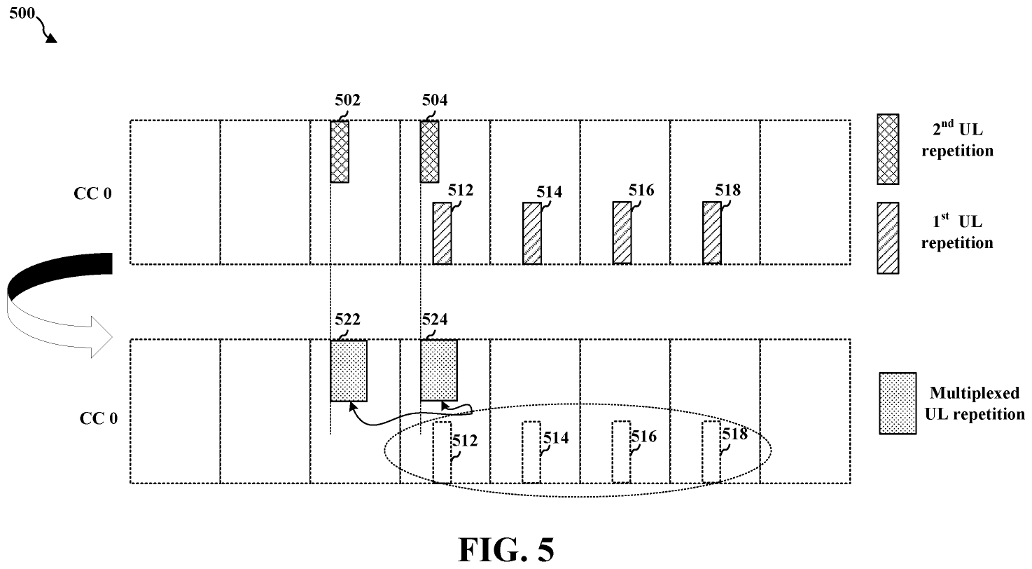

FIG. 5 is a diagram illustrating another example 500 of multiplexed uplink channel transmission repetitions, in accordance with some aspects of the present disclosure. The example 500 includes a first set of uplink channel transmission repetitions (e.g., 512, 514, 516, 518) and a second set of uplink channel transmission repetitions (e.g., 502, 504). As illustrated in FIG. 5, the user equipment may determine that uplink channel transmission repetition 512 overlaps with the uplink channel transmission repetition 504, respectively. In some aspects, the overlapping may occur on one or more symbols within a slot. For example, the uplink channel transmission repetition 512 may overlap the uplink channel transmission repetition 506 by at least one symbol. The user equipment may multiplex the uplink channel transmission repetitions 512-518 into the uplink channel transmission repetitions 502 and 504 to form a set of multiplexed uplink repetitions 522 and 524. Consequently, the uplink channel transmission repetitions 512-518 may be dropped.

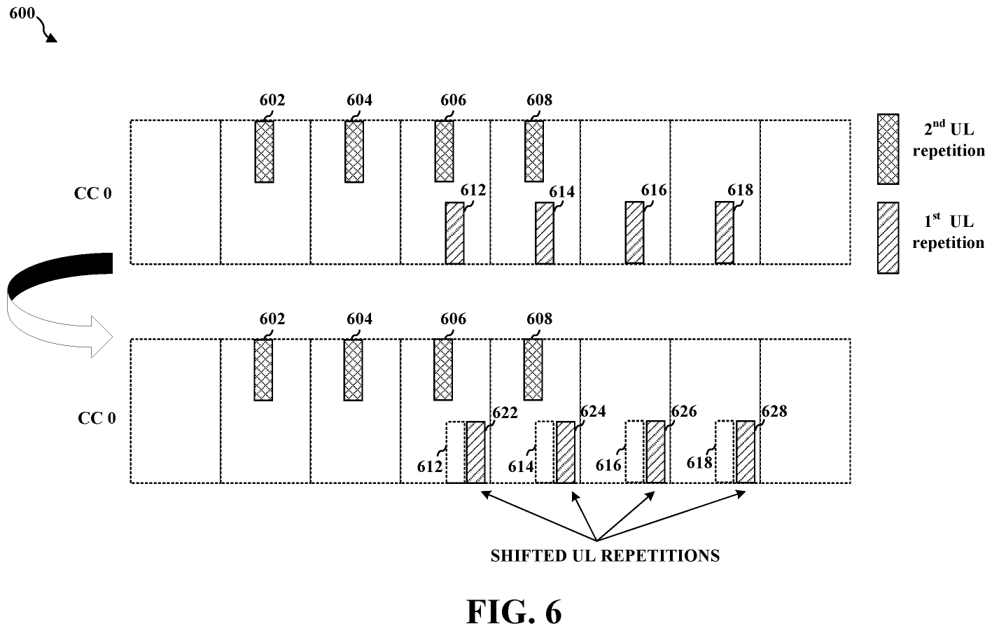

FIG. 6 is a diagram illustrating an example 600 of shifted uplink channel transmission repetitions, in accordance with some aspects of the present disclosure. The example 600 includes a first set of uplink channel transmission repetitions (e.g., 612, 614, 616, 618) and a second set of uplink channel transmission repetitions (e.g., 602, 604, 606, 608). As illustrated in FIG. 6, the user equipment may determine that uplink channel transmission repetitions 612 and 614 overlaps with the uplink channel transmission repetitions 606 and 608, respectively. In some aspects, the overlapping may occur on one or more symbols within a slot. For example, the uplink channel transmission repetition 612 may overlap the uplink channel transmission repetition 606 by at least one symbol. In this regard, the overlapping of the uplink repetitions may cause an increase in resource utilization to retransmit the overlapped uplink repetitions at a later time. To increase the transmission efficiency of uplink repetitions, the overlapped uplink repetitions can be shifted to a different repetition location.

The user equipment may modify the uplink channel transmission repetitions 612-618 based on the second set of uplink channel transmission repetitions. In various aspects, the user equipment can modify the uplink channel transmission repetitions 612-618 by shifting the uplink channel transmission repetitions 612-618 from a first repetition location to a second repetition location to form a set of shifted uplink repetitions 622, 624, 626, 628. Consequently, the uplink channel transmission repetitions 612-618 may be dropped. In some aspects, the uplink channel transmission repetitions 612-618 may be shifted by at least one symbol away from the uplink channel transmission repetitions 602, 604, 606, 608. As illustrated in FIG. 6, the uplink channel transmission repetitions 612-618 is shifted to the right by at least one symbol within each respective slot. In other aspects, the uplink channel transmission repetitions 612-618 may be shifted by one or more slots for slot-based uplink resources. In still other aspects, the uplink channel transmission repetitions 612-618 may be shifted by one or more sub-slots for sub-slot-based uplink resources.

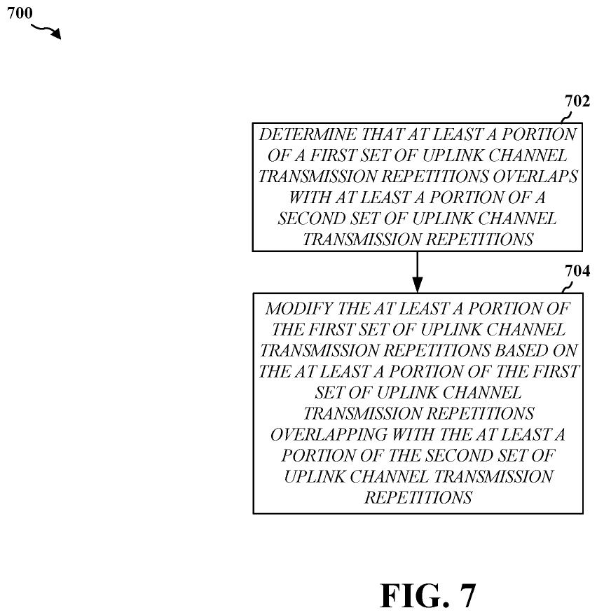

FIG. 7 is a flowchart of a process 700 of wireless communication for multiplexing of overlapped uplink channel transmission repetitions at a user equipment, in accordance with some aspects of the present disclosure. The process 700 may be performed by a user equipment (e.g., the UE 104; the UE 350, the RSU 107). As illustrated, the process 700 includes a number of enumerated steps, but embodiments of the process 700 may include additional steps before, after, and in between the enumerated steps. In some embodiments, one or more of the enumerated steps may be omitted or performed in a different order. Optional aspects are illustrated with a dashed line.

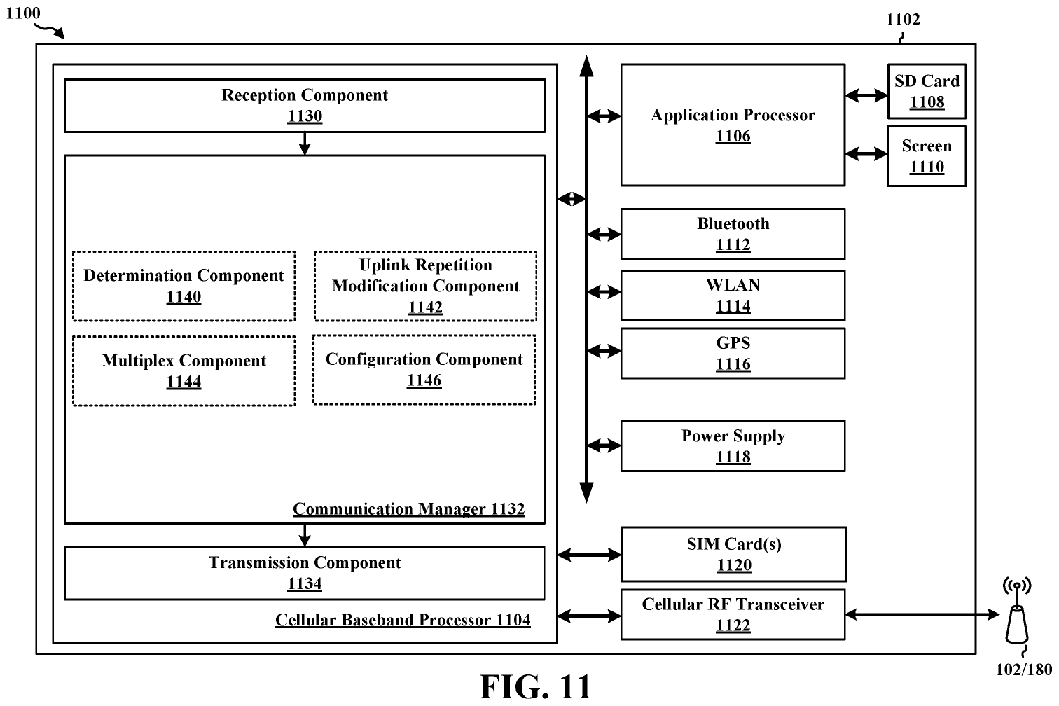

At 702, the user equipment can determine that at least a portion of a first set of uplink channel transmission repetitions overlaps with at least a portion of a second set of uplink channel transmission repetitions. The user equipment can determine that the at least a portion of the first set of uplink channel transmission repetitions is overlapped, e.g., as described in connection with FIGS. 1-6. For instance, 702 may be performed by one or more components described with respect to FIG. 3, e.g., controller/processor 359, receive processor 356, transmit processor 368, receiver/transmitter 354 and/or antenna 352. The at least a portion of the first set of uplink channel transmission repetitions overlapping with the at least a portion of the second set of uplink channel transmission repetitions may be determined, e.g., by the determination component 1140 of the apparatus 1102 in FIG. 11.

At 704, the user equipment can modify the at least a portion of the first set of uplink channel transmission repetitions based on the at least a portion of the first set of uplink channel transmission repetitions overlapping with the at least a portion of the second set of uplink channel transmission repetitions. The user equipment can modify the first set of uplink channel transmission repetitions, e.g., as described in connection with FIGS. 1-6. For instance, 704 may be performed by one or more components described with respect to FIG. 3, e.g., controller/processor 359, transmit processor 368, receiver/transmitter 354 and/or antenna 352. The first set of uplink channel transmission repetitions may be modified, e.g., by the uplink repetition modification component 1142 of the apparatus 1102 in FIG. 11.

In some aspects, the first set of uplink channel transmission repetitions starts at a first time and the second set of uplink channel transmission repetitions starts at a second time that precedes the first time by one or more slots. In other aspects, the first set of uplink channel transmission repetitions starts at a first time and the second set of uplink channel transmission repetitions starts at a second time that precedes the first time by one or more sub-slots.

In some aspects, the first set of uplink channel transmission repetitions starts at a first time and the second set of uplink channel transmission repetitions starts at a second time that is subsequent to the first time by one or more slots. In some aspects, the first set of uplink channel transmission repetitions starts at a first time and the second set of uplink channel transmission repetitions starts at a second time that is subsequent to the first time by one or more sub-slots.

In some aspects, the first set of uplink channel transmission repetitions is associated with a first physical layer priority and the second set of uplink channel transmission repetitions is associated with a second physical layer priority that is smaller than the first physical layer priority. In some aspects, the first set of uplink channel transmission repetitions is associated with a first physical layer priority and the second set of uplink channel transmission repetitions is associated with a second physical layer priority that is greater than the first physical layer priority.

In some aspects, the first set of uplink channel transmission repetitions is associated with a first uplink control information priority and the second set of uplink channel transmission repetitions is associated with a second uplink control information priority that is smaller than the first uplink control information priority. In some aspects, the second set of uplink channel transmission repetitions includes repetitions containing SR information and the first set of uplink channel transmission repetitions comprises repetitions containing HARQ-ACK information. In some aspects, the second set of uplink channel transmission repetitions includes repetitions containing CSI report information and the first set of uplink channel transmission repetitions comprises repetitions containing SR information. In some aspects, the second set of uplink channel transmission repetitions comprises repetitions containing CSI report information and the first set of uplink channel transmission repetitions comprises repetitions containing HARQ-ACK information.

In some aspects, the first set of uplink channel transmission repetitions is associated with a first uplink control information priority and the second set of uplink channel transmission repetitions is associated with a second uplink control information priority that is greater than the first uplink control information priority. In some aspects, the first set of uplink channel transmission repetitions comprises repetitions containing SR information and the second set of uplink channel transmission repetitions comprises repetitions containing HARQ-ACK information. In some aspects, the first set of uplink channel transmission repetitions comprises repetitions containing CSI report information and the second set of uplink channel transmission repetitions comprises repetitions containing SR information. In some aspects, the first set of uplink channel transmission repetitions comprises repetitions containing CSI report information and the second set of uplink channel transmission repetitions comprises repetitions containing HARQ-ACK information.

In some aspects, the first set of uplink channel transmission repetitions has a first number of repetitions and the second set of uplink channel transmission repetitions has a second number of repetitions that is greater than the first number of repetitions. In some aspects, the first set of uplink channel transmission repetitions has a first number of repetitions and the second set of uplink channel transmission repetitions has a second number of repetitions that is smaller than the first number of repetitions.

In some aspects, the first set of uplink channel transmission repetitions and the second set of uplink channel transmission repetitions correspond to one of a plurality of uplink physical channel combinations, and wherein at least one of the plurality of uplink physical channel combinations includes both slot-based resources and sub-slot-based resources. In some aspects, a first of the plurality of uplink physical channel combinations comprises the first set of uplink channel transmission repetitions having PUCCH repetitions and the second set of uplink channel transmission repetitions having PUCCH repetitions. In some aspects, a second of the plurality of uplink physical channel combinations comprises the first set of uplink channel transmission repetitions having PUCCH repetitions and the second set of uplink channel transmission repetitions having PUSCH repetitions. In some aspects, a third of the plurality of uplink physical channel combinations comprises the first set of uplink channel transmission repetitions having PUSCH repetitions and the second set of uplink channel transmission repetitions having PUCCH repetitions. In some aspects, a first of the plurality of uplink physical channel combinations comprises the first set of uplink channel transmission repetitions having PUSCH repetitions and the second set of uplink channel transmission repetitions having PUSCH repetitions. In some aspects, the plurality of uplink physical channel combinations includes one or more of PUCCH repetitions or PUSCH repetitions, in which the PUCCH repetitions are used for a CG, an uplink DG, uplink feedback for SPS, or uplink feedback for downlink DG, and wherein the PUSCH repetitions are used for uplink feedback for SPS or uplink feedback for DL DG.

In some aspects, the first set of uplink channel transmission repetitions comprises repetitions containing HARQ-ACK information. In some aspects, the user equipment can modify the HARQ-ACK information into a bundled dataset by a binary operation. In some aspects, the uplink repetition sequence to be bundled can depend on the LP/HP PHY priority, UCI priority, later/earlier starting slot, or more/less number of repetitions in the uplink repetition sequence. In some aspects, the user equipment can multiplex the bundled dataset including the HARQ-ACK information into the second set of uplink channel transmission repetitions.

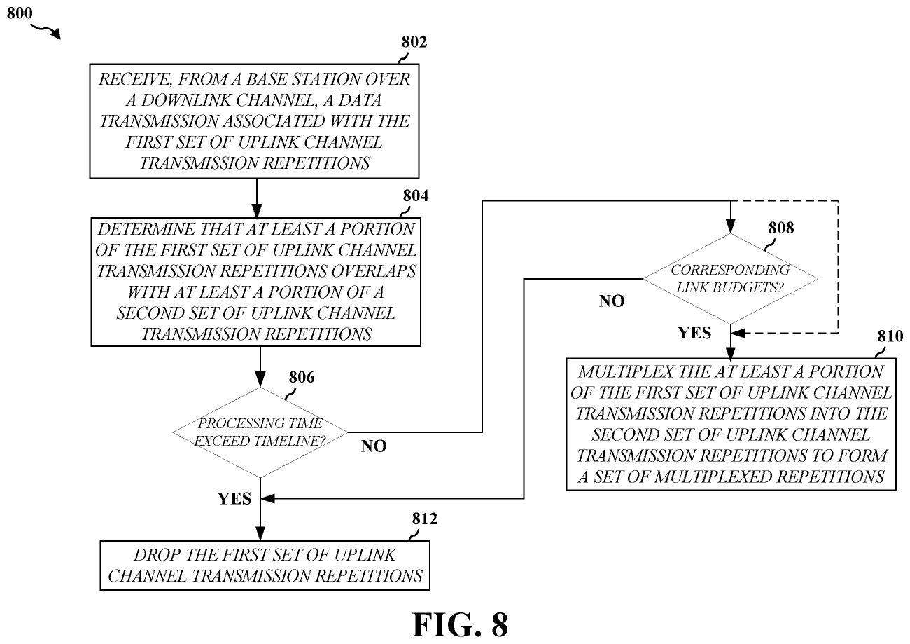

FIG. 8 is a flowchart of a process 800 of wireless communication for multiplexing of overlapped uplink channel transmission repetitions at a user equipment, in accordance with some aspects of the present disclosure. The process 800 may be performed by a user equipment (e.g., the UE 104; the UE 350, the RSU 107). As illustrated, the process 800 includes a number of enumerated steps, but embodiments of the process 800 may include additional steps before, after, and in between the enumerated steps. In some embodiments, one or more of the enumerated steps may be omitted or performed in a different order. Optional aspects are illustrated with a dashed line.

At 802, the user equipment may receive, from a base station over a downlink channel, a data transmission associated with the first set of uplink channel transmission repetitions at a first time. The user equipment can receive the data transmission, e.g., as described in connection with FIGS. 1-6. In some aspects, the second set of uplink channel transmission repetitions starts at a second time, in which the first time and the second time are separated by a timeline. For instance, 802 may be performed by one or more components described with respect to FIG. 3, e.g., controller/processor 359, receive processor 356, receiver/transmitter 354 and/or antenna 352. The data transmission associated with the first set of uplink channel transmission repetitions may be received, e.g., by the reception component 1130 of the apparatus 1102 in FIG. 11.

At 804, the user equipment may determine that at least a portion of a first set of uplink channel transmission repetitions overlaps with at least a portion of a second set of uplink channel transmission repetitions. The user equipment can determine that the at least a portion of the first set of uplink channel transmission repetitions is overlapped, e.g., as described in connection with FIGS. 1-6. For instance, 804 may be performed by one or more components described with respect to FIG. 3, e.g., controller/processor 359, receive processor 356, transmit processor 368, receiver/transmitter 354 and/or antenna 352. The at least a portion of the first set of uplink channel transmission repetitions overlapping with the at least a portion of the second set of uplink channel transmission repetitions may be determined, e.g., by the determination component 1140 of the apparatus 1102 in FIG. 11.

At 806, the user equipment may determine whether a processing time to decode the data transmission exceeds the timeline. For example, the timeline is to be satisfied for the relocated uplink repetition for the multiplexing (e.g., the contents are to be ready when multiplexed into the target uplink repetition). If the processing time exceeds the timeline, the process 800 proceeds to block 812. Otherwise, if the processing time does not exceed the timeline, the process 800 proceeds to block 808. In some implementations, the process 800 may proceed from block 806 to block 810 (bypassing the block 808). For example, at 810, the multiplexing is performed when the processing time does not exceed the timeline. The user equipment can compare the processing time to the timeline, e.g., as described in connection with FIGS. 1-6. For instance, 806 may be performed by one or more components described with respect to FIG. 3, e.g., controller/processor 359, receive processor 356, transmit processor 368, receiver/transmitter 354 and/or antenna 352. The processing time to decode the data transmission of whether it exceeds the timeline may be determined, e.g., by the determination component 1140 of the apparatus 1102 in FIG. 11.

At 808, the user equipment may determine whether each multiplexed repetition in the set of multiplexed repetitions has a first link budget that corresponds to a second link budget of each repetition in the second set of uplink channel transmission repetitions. For example, a determination can be made to see if each multiplexed repetition can accommodate both original and added payloads with the same or similar link budget (e.g. same or at least X % increased spectral efficiency). In some aspects, the multiplexing is performed when the first link budget corresponds to the second link budget and the processing time does not exceed the timeline. In other aspects, the multiplexing is not performed and the first set of uplink channel transmission repetitions is dropped when the first link budget does not correspond to the second link budget and the processing time exceeds the timeline. For example, the process 800 proceeds from block 808 to block 810 when corresponding link budgets is detected. Otherwise, the process 800 proceeds from block 808 to block 812 when corresponding link budgets is not detected. The user equipment can compare the processing time to the timeline, e.g., as described in connection with FIGS. 1-6. For instance, 808 may be performed by one or more components described with respect to FIG. 3, e.g., controller/processor 359, receive processor 356, transmit processor 368, receiver/transmitter 354 and/or antenna 352. The multiplexed repetitions in the set of multiplexed repetitions of whether each has a first link budget that corresponds to a second link budget of each repetition in the second set of uplink channel transmission repetition may be determined, e.g., by the determination component 1140 and/or the multiplex component 1144 of the apparatus 1102 in FIG. 11.

At 810, the user equipment may multiplex the at least a portion of the first set of uplink channel transmission repetitions into the second set of uplink channel transmission repetitions to form a set of multiplexed repetitions. The user equipment can multiplex the at least a portion of the first set of uplink channel transmission repetitions and the second set of uplink channel transmission repetitions, e.g., as described in connection with FIGS. 1-6. For instance, 810 may be performed by one or more components described with respect to FIG. 3, e.g., controller/processor 359, receive processor 356, transmit processor 368, receiver/transmitter 354 and/or antenna 352. The first set of uplink channel transmission repetitions and the second set of uplink channel transmission repetitions may be multiplexed, e.g., by the multiplex component 1144 of the apparatus 1102 in FIG. 11.

At 812, the user equipment may drop the first set of uplink channel transmission repetitions when the processing time exceeds the timeline. In some aspects, the multiplexing is not performed when the first set of uplink channel transmission repetitions is dropped. The user equipment can drop the first set of uplink channel transmission repetitions, e.g., as described in connection with FIGS. 1-6. For instance, 812 may be performed by one or more components described with respect to FIG. 3, e.g., controller/processor 359, transmit processor 368, receiver/transmitter 354 and/or antenna 352. The first set of uplink channel transmission repetitions may be dropped, e.g., by the uplink repetition modification component 1142 (and optionally through cooperation with the determination component 1140) of the apparatus 1102 in FIG. 11.

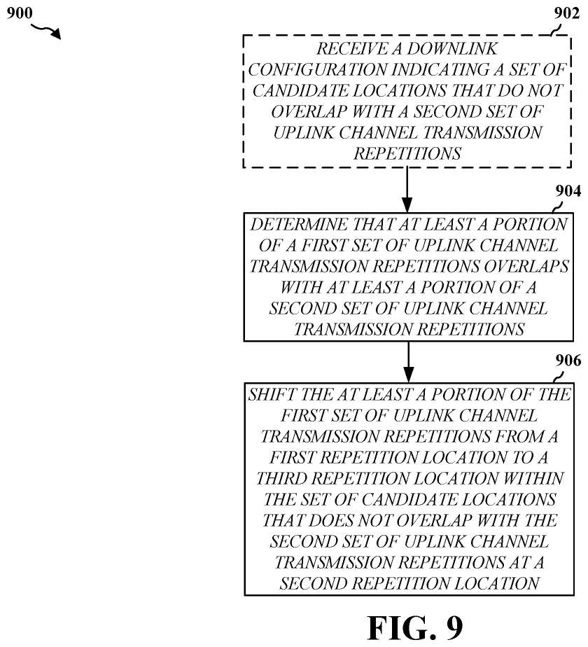

FIG. 9 is a flowchart of a process 900 of wireless communication for multiplexing of overlapped uplink channel transmission repetitions at a user equipment, in accordance with some aspects of the present disclosure. The process 900 may be performed by a user equipment (e.g., the UE 104; the UE 350, the RSU 107). As illustrated, the process 900 includes a number of enumerated steps, but embodiments of the process 900 may include additional steps before, after, and in between the enumerated steps. In some embodiments, one or more of the enumerated steps may be omitted or performed in a different order. Optional aspects are illustrated with a dashed line.

At 902, the user equipment may receive, from a base station over a downlink channel, a configuration indicating a set of candidate locations that do not overlap with the second set of uplink channel transmission repetitions at the second repetition location. In some aspects, the third repetition location corresponds to an earliest available location within the set of candidate locations. The user equipment can receive the configuration, e.g., as described in connection with FIGS. 1-6. For instance, 902 may be performed by one or more components described with respect to FIG. 3, e.g., controller/processor 359, receive processor 356, receiver/transmitter 354 and/or antenna 352. The downlink configuration may be received, e.g., by the configuration component 1146 via the reception component 1130 of the apparatus 1102 in FIG. 11.

At 904, the user equipment may determine that at least a portion of a first set of uplink channel transmission repetitions overlaps with at least a portion of a second set of uplink channel transmission repetitions. The user equipment can determine that the at least a portion of the first set of uplink channel transmission repetitions is overlapped, e.g., as described in connection with FIGS. 1-6. For instance, 904 may be performed by one or more components described with respect to FIG. 3, e.g., controller/processor 359, receive processor 356, transmit processor 368, receiver/transmitter 354 and/or antenna 352. The first set of uplink channel transmission repetitions overlapping with the at least a portion of the second set of uplink channel transmission repetitions may be determined, e.g., by the determination component 1140 of the apparatus 1102 in FIG. 11.

At 906, the user equipment may shift the at least a portion of the first set of uplink channel transmission repetitions from a first repetition location to a third repetition location. In some aspects, the first set of uplink channel transmission repetitions at the third repetition location does not overlap with the second set of uplink channel transmission repetitions at a second repetition location. The user equipment can shift the at least a portion of the first set of uplink channel transmission repetitions, e.g., as described in connection with FIGS. 1-6. In some aspects, the user equipment may determine a plurality of possible locations that do not overlap with the second set of uplink channel transmission repetitions at the second repetition location, wherein the third repetition location corresponds to an earliest available location within the plurality of possible locations. In some aspects, the first set of uplink channel transmission repetitions is shifted by one or more symbols within a same slot. In some aspects, the first set of uplink channel transmission repetitions is shifted by one or more sub-slots within a same slot. For instance, 906 may be performed by one or more components described with respect to FIG. 3, e.g., controller/processor 359, transmit processor 368, receiver/transmitter 354 and/or antenna 352. The at least a portion of the first set of uplink channel transmission repetitions may be shifted, e.g., by the uplink repetition modification component 1142 (and optionally through cooperation with the determination component 1140) of the apparatus 1102 in FIG. 11.

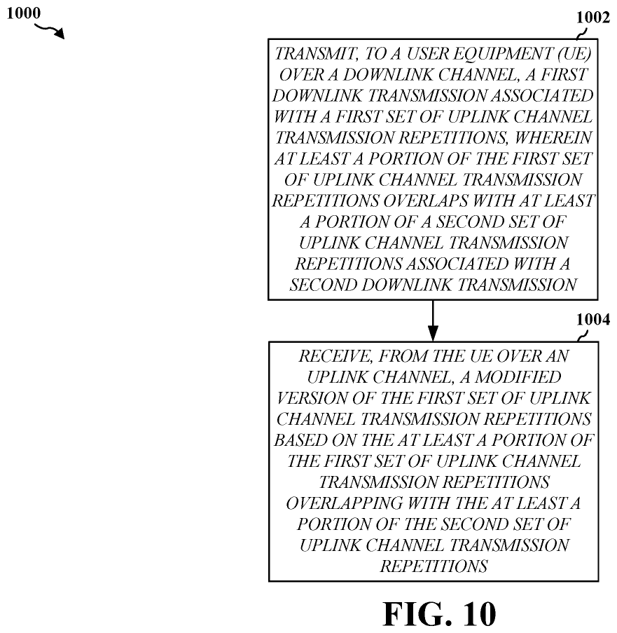

FIG. 10 is a flowchart of a process 1000 of wireless communication for multiplexing of overlapped uplink channel transmission repetitions at a base station, in accordance with some aspects of the present disclosure. The process 1000 may be performed by a base station (e.g., the BS 102, 180; the base station 310). As illustrated, the process 1000 includes a number of enumerated steps, but embodiments of the process 1000 may include additional steps before, after, and in between the enumerated steps. In some embodiments, one or more of the enumerated steps may be omitted or performed in a different order. Optional aspects are illustrated with a dashed line.

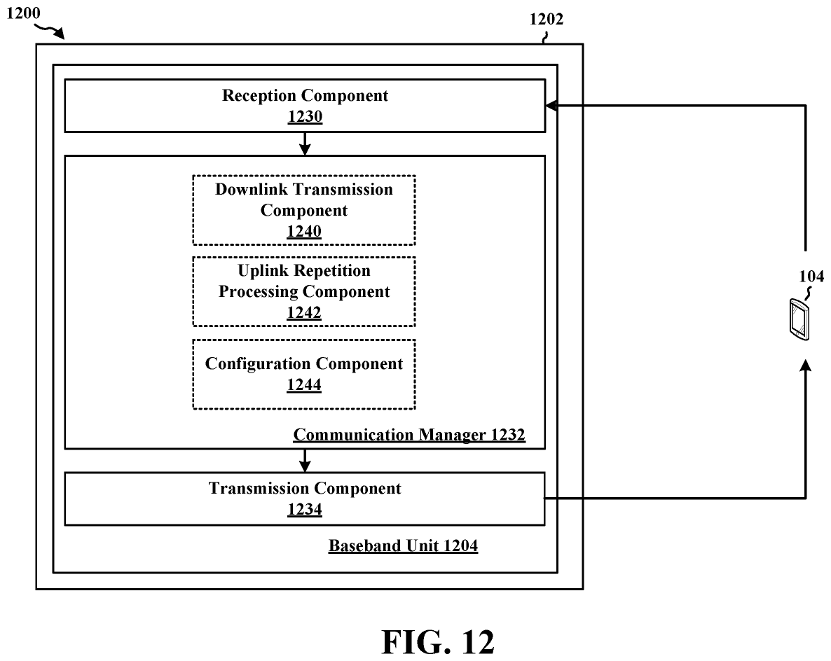

At 1002, the base station may transmit, to a UE over a downlink channel, a first downlink transmission associated with a first set of uplink channel transmission repetitions, in which at least a portion of the first set of uplink channel transmission repetitions overlaps with at least a portion of a second set of uplink channel transmission repetitions associated with a second downlink transmission. The base station can transmit the first downlink transmission, e.g., as described in connection with FIGS. 1-6. For instance, 1002 may be performed by one or more components described with respect to FIG. 3, e.g., controller/processor 375, transmit processor 316, receiver/transmitter 318 and/or antenna 320. The first downlink transmission associated with the first set of uplink channel transmission repetitions may be transmitted, e.g., by the downlink transmission component 1240 via the transmission component 1234 of the apparatus 1202 in FIG. 12.

At 1004, the base station may receive, from the UE over an uplink channel, a modified version of the first set of uplink channel transmission repetitions based on the at least a portion of the first set of uplink channel transmission repetitions overlapping with the at least a portion of the second set of uplink channel transmission repetitions. The base station can receive the second set of uplink channel transmission repetitions, e.g., as described in connection with FIGS. 1-6. For instance, 1004 may be performed by one or more components described with respect to FIG. 3, e.g., controller/processor 375, receive processor 370, receiver/transmitter 318 and/or antenna 320. The modified version of the first set of uplink channel transmission repetitions may be received, e.g., by the uplink repetition processing component 1242 via the reception component 1230 of the apparatus 1202 in FIG. 12.

In some aspects, the base station can receive the modified version of the first set of uplink channel transmission repetitions comprises receiving, from the UE over the uplink channel, the first set of uplink channel transmission repetitions multiplexed into the second set of uplink channel transmission repetitions.

In some aspects receiving the modified version of the first set of uplink channel transmission repetitions, the base station can receive, from the UE over the uplink channel, the first set of uplink channel transmission repetitions shifted from a first repetition location to a third repetition location, in which the first set of uplink channel transmission repetitions at the third repetition location does not overlap with the second set of uplink channel transmission repetitions at a second repetition location.

In some aspects, the base station can transmit, to the UE over a downlink channel, a configuration indicating a set of candidate locations that do not overlap with the second set of uplink channel transmission repetitions at the second repetition location. In some aspects, the third repetition location corresponds to an earliest available location within the set of candidate locations. For instance, configuration transmission may be performed by one or more components described with respect to FIG. 3, e.g., controller/processor 375, transmit processor 316, receiver/transmitter 318 and/or antenna 320. The downlink configuration may be transmitted, e.g., by the configuration component 1244 via the transmission component 1234 of the apparatus 1202 in FIG. 12.

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 114 and/or BS 112/180. The cellular baseband processor 1104 may include a computer-readable medium/memory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software.

The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the aforementioned additional modules of the apparatus 1102.

The communication manager 1132 includes a determination component 1140, an uplink repetition modification component 1142, a multiplex component 1144 and a configuration component 1146. The apparatus may include additional components that perform each of the blocks of the algorithm in the aforementioned flowcharts of FIGS. 7-9. As such, each block in the aforementioned flowcharts of FIGS. 7-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for determining that a first set of uplink channel transmission repetitions overlaps with at least a portion of a second set of uplink channel transmission repetitions; and means for modifying the first set of uplink channel transmission repetitions based on the second set of uplink channel transmission repetitions.

The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 12 is a diagram 1200 illustrating an example of a hardware implementation for an apparatus 1202. The apparatus 1202 is a BS and includes a baseband unit 1204. The baseband unit 1204 may communicate through a cellular RF transceiver with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the BS 310 and may include the memory 376 and/or at least one of the TX processor 316, the RX processor 370, and the controller/processor 375.

The communication manager 1232 includes a downlink transmission component 1240, an uplink repetition processing component 1242 and a configuration component 1244. The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for transmitting, to a user equipment (UE) over a downlink channel, a first downlink transmission associated with a first set of uplink channel transmission repetitions, wherein the first set of uplink channel transmission repetitions overlaps with at least a portion of a second set of uplink channel transmission repetitions associated with a second downlink transmission; and means for receiving, from the UE over an uplink channel, a modified version of the first set of uplink channel transmission repetitions based on the second set of uplink channel transmission repetitions.

The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The following clauses are illustrative only and may be combined with aspects of other embodiments or teachings described herein, without limitation.

Clause 1 is a method of wireless communication at a user equipment that includes determining that at least a portion of a first set of uplink channel transmission repetitions overlaps with at least a portion of a second set of uplink channel transmission repetitions; and modifying the at least a portion of the first set of uplink channel transmission repetitions based on the at least a portion of the first set of uplink channel transmission repetitions overlapping with the at least a portion of the second set of uplink channel transmission repetitions.

In Clause 2, the method of Clause 1 includes that the modifying comprises multiplexing the at least a portion of the first set of uplink channel transmission repetitions into the second set of uplink channel transmission repetitions to form a set of multiplexed repetitions.

In Clause 3, the method of Clause 1 or Clause 2 includes receiving, from a base station over a downlink channel, a data transmission associated with the first set of uplink channel transmission repetitions at a first time, wherein the second set of uplink channel transmission repetitions starts at a second time, wherein the first time and the second time are separated by a timeline; determining whether a processing time to decode the data transmission exceeds the timeline, wherein the multiplexing is performed when the processing time does not exceed the timeline, and wherein the multiplexing is not performed and the first set of uplink channel transmission repetitions is dropped when the processing time exceeds the timeline.

In Clause 4, the method of any of Clauses 1-3 includes determining whether each multiplexed repetition in the set of multiplexed repetitions has a first link budget that corresponds to a second link budget of each repetition in the second set of uplink channel transmission repetitions, wherein the multiplexing is performed when the first link budget corresponds to the second link budget and the processing time does not exceed the timeline, and wherein the multiplexing is not performed and the first set of uplink channel transmission repetitions is dropped when the first link budget does not correspond to the second link budget and the processing time exceeds the timeline.

In Clause 5, the method of any of Clauses 1-4 includes determining the first link budget based on a size of a first payload in each multiplexed repetition of the set of multiplexed repetitions.

In Clause 6, the method of any of Clauses 1-5 includes determining the second link budget based on a size of a second payload in each repetition of the second set of uplink channel transmission repetitions; determining a payload difference between the first payload and the second payload for each multiplexed repetition of the set of multiplexed repetitions; and determining whether the payload difference exceeds a payload threshold, wherein the multiplexing is performed when the payload difference does not exceed the payload threshold, and wherein the multiplexing is not performed when the payload difference exceeds the payload threshold.

In Clause 7, the method of any of Clauses 1-6 includes that the modifying comprises shifting the first set of uplink channel transmission repetitions from a first repetition location to a third repetition location, wherein the first set of uplink channel transmission repetitions at the third repetition location does not overlap with the second set of uplink channel transmission repetitions at a second repetition location.

In Clause 8, the method of any of Clauses 1-7 includes determining a plurality of possible locations that do not overlap with the second set of uplink channel transmission repetitions at the second repetition location, wherein the third repetition location corresponds to an earliest available location within the plurality of possible locations.

In Clause 9, the method of any of Clauses 1-8 includes receiving, from a base station over a downlink channel, a configuration indicating a set of candidate locations that do not overlap with the second set of uplink channel transmission repetitions at the second repetition location, wherein the third repetition location corresponds to an earliest available location within the set of candidate locations.

In Clause 10, the method of any of Clauses 1-9 includes that the first set of uplink channel transmission repetitions is shifted by one or more symbols within a same slot.

In Clause 11, the method of any of Clauses 1-10 includes that the first set of uplink channel transmission repetitions is shifted by one or more sub-slots within a same slot.

In Clause 12, the method of any of Clauses 1-11 includes that the first set of uplink channel transmission repetitions starts at a first time and the second set of uplink channel transmission repetitions starts at a second time that precedes the first time by one or more slots.

In Clause 13, the method of any of Clauses 1-12 includes that the first set of uplink channel transmission repetitions starts at a first time and the second set of uplink channel transmission repetitions starts at a second time that precedes the first time by one or more sub-slots.

In Clause 14, the method of any of Clauses 1-13 includes that the first set of uplink channel transmission repetitions starts at a first time and the second set of uplink channel transmission repetitions starts at a second time that is subsequent to the first time by one or more slots.

In Clause 15, the method of any of Clauses 1-14 includes that the first set of uplink channel transmission repetitions starts at a first time and the second set of uplink channel transmission repetitions starts at a second time that is subsequent to the first time by one or more sub-slots.

In Clause 16, the method of any of Clauses 1-15 includes that the first set of uplink channel transmission repetitions is associated with a first physical layer priority and the second set of uplink channel transmission repetitions is associated with a second physical layer priority that is lower than the first physical layer priority.

In Clause 17, the method of any of Clauses 1-16 includes that the first set of uplink channel transmission repetitions is associated with a first physical layer priority and the second set of uplink channel transmission repetitions is associated with a second physical layer priority that is higher than the first physical layer priority.

In Clause 18, the method of any of Clauses 1-17 includes that the first set of uplink channel transmission repetitions is associated with a first uplink control information priority and the second set of uplink channel transmission repetitions is associated with a second uplink control information priority that is lower than the first uplink control information priority.

In Clause 19, the method of any of Clauses 1-18 includes that the second set of uplink channel transmission repetitions comprises repetitions containing scheduling request (SR) information and the first set of uplink channel transmission repetitions comprises repetitions containing hybrid automatic repeat request (HARQ) acknowledgment (ACK) information.

In Clause 20, the method of any of Clauses 1-19 includes that the second set of uplink channel transmission repetitions comprises repetitions containing channel state information (CSI) report information and the first set of uplink channel transmission repetitions comprises repetitions containing scheduling request (SR) information.

In Clause 21, the method of any of Clauses 1-20 includes that the second set of uplink channel transmission repetitions comprises repetitions containing channel state information (CSI) report information and the first set of uplink channel transmission repetitions comprises repetitions containing hybrid automatic repeat request (HARQ) acknowledgment (ACK) information.

In Clause 22, the method of any of Clauses 1-21 includes that the first set of uplink channel transmission repetitions is associated with a first uplink control information priority and the second set of uplink channel transmission repetitions is associated with a second uplink control information priority that is higher than the first uplink control information priority.

In Clause 23, the method of any of Clauses 1-22 includes that the first set of uplink channel transmission repetitions comprises repetitions containing scheduling request (SR) information and the second set of uplink channel transmission repetitions comprises repetitions containing hybrid automatic repeat request (HARQ) acknowledgment (ACK) information.

In Clause 24, the method of any of Clauses 1-23 includes that the first set of uplink channel transmission repetitions comprises repetitions containing channel state information (CSI) report information and the second set of uplink channel transmission repetitions comprises repetitions containing scheduling request (SR) information.

In Clause 25, the method of any of Clauses 1-24 includes that the first set of uplink channel transmission repetitions comprises repetitions containing channel state information (CSI) report information and the second set of uplink channel transmission repetitions comprises repetitions containing hybrid automatic repeat request (HARQ) acknowledgment (ACK) information.

In Clause 26, the method of any of Clauses 1-25 includes that the first set of uplink channel transmission repetitions has a first number of repetitions and the second set of uplink channel transmission repetitions has a second number of repetitions that is greater than the first number of repetitions.

In Clause 27, the method of any of Clauses 1-26 includes that the first set of uplink channel transmission repetitions has a first number of repetitions and the second set of uplink channel transmission repetitions has a second number of repetitions that is smaller than the first number of repetitions.

In Clause 28, the method of any of Clauses 1-27 includes that the first set of uplink channel transmission repetitions and the second set of uplink channel transmission repetitions correspond to one of a plurality of uplink physical channel combinations, and wherein at least one of the plurality of uplink physical channel combinations includes both slot-based resources and sub-slot-based resources.

In Clause 29, the method of any of Clauses 1-28 includes that a first of the plurality of uplink physical channel combinations comprises the first set of uplink channel transmission repetitions having physical uplink control channel (PUCCH) repetitions and the second set of uplink channel transmission repetitions having PUCCH repetitions.

In Clause 30, the method of any of Clauses 1-29 includes that a second of the plurality of uplink physical channel combinations comprises the first set of uplink channel transmission repetitions having physical uplink control channel (PUCCH) repetitions and the second set of uplink channel transmission repetitions having physical uplink shared channel (PUSCH) repetitions.

In Clause 31, the method of any of Clauses 1-30 includes that a third of the plurality of uplink physical channel combinations comprises the first set of uplink channel transmission repetitions having physical uplink shared channel (PUSCH) repetitions and the second set of uplink channel transmission repetitions having physical uplink control channel (PUCCH) repetitions.

In Clause 32, the method of any of Clauses 1-31 includes that a first of the plurality of uplink physical channel combinations comprises the first set of uplink channel transmission repetitions having physical uplink shared channel (PUSCH) repetitions and the second set of uplink channel transmission repetitions having PUSCH repetitions.

In Clause 33, the method of any of Clauses 1-32 includes that the plurality of uplink physical channel combinations comprises one or more of physical uplink control channel (PUCCH) repetitions or physical uplink shared channel (PUSCH) repetitions, wherein the PUCCH repetitions are used for a configured grant (CG), an uplink dynamic grant (DG), uplink feedback for semi-persistent scheduling (SPS), or uplink feedback for downlink DG, and wherein the PUSCH repetitions are used for uplink feedback for SPS or uplink feedback for DL DG.

In Clause 34, the method of any of Clauses 1-33 includes that the first set of uplink channel transmission repetitions comprises repetitions containing hybrid automatic repeat request (HARD)-acknowledgment (ACK) information, and the modifying the first set of uplink channel transmission repetitions comprises: modifying the HARQ-ACK information into a bundled dataset by a binary operation, and multiplexing the bundled dataset comprising the HARQ-ACK information into the second set of uplink channel transmission repetitions.

Clause 35 is a device including one or more processors and one or more memories in electronic communication with the one or more processors storing instructions executable by the one or more processors to cause the system or apparatus to implement a method as in any of Clauses 1 to 34.

Clause 36 is a system or apparatus including means for implementing a method or realizing an apparatus as in any of Clauses 1 to 34.

Clause 37 is a non-transitory computer readable medium storing instructions executable by one or more processors to cause the one or more processors to implement a method as in any of Clauses 1 to 34.

Clause 38 is a method of wireless communication at a base station that includes transmitting, to a user equipment (UE) over a downlink channel, a first downlink transmission associated with a first set of uplink channel transmission repetitions, wherein at least a portion of the first set of uplink channel transmission repetitions overlaps with at least a portion of a second set of uplink channel transmission repetitions associated with a second downlink transmission; and receiving, from the UE over an uplink channel, a modified version of the first set of uplink channel transmission repetitions based on the at least a portion of the first set of uplink channel transmission repetitions overlapping with the at least a portion of the second set of uplink channel transmission repetitions.

In Clause 39, the method of Clause 38 includes that the receiving the modified version of the first set of uplink channel transmission repetitions comprises receiving, from the UE over the uplink channel, the first set of uplink channel transmission repetitions multiplexed into the second set of uplink channel transmission repetitions.

In Clause 40, the method of Clause 38 or Clause 39 includes that the receiving the modified version of the first set of uplink channel transmission repetitions comprises receiving, from the UE over the uplink channel, the first set of uplink channel transmission repetitions shifted from a first repetition location to a third repetition location, wherein the first set of uplink channel transmission repetitions at the third repetition location does not overlap with the second set of uplink channel transmission repetitions at a second repetition location.

In Clause 41, the method of any of Clauses 38-40 includes transmitting, to the UE over a downlink channel, a configuration indicating a set of candidate locations that do not overlap with the second set of uplink channel transmission repetitions at the second repetition location, wherein the third repetition location corresponds to an earliest available location within the set of candidate locations.

Clause 42 is a device including one or more processors and one or more memories in electronic communication with the one or more processors storing instructions executable by the one or more processors to cause the system or apparatus to implement a method as in any of Clauses 38 to 41.

Clause 43 is a system or apparatus including means for implementing a method or realizing an apparatus as in any of Clauses 38 to 41.

Clause 44 is a non-transitory computer readable medium storing instructions executable by one or more processors to cause the one or more processors to implement a method as in any of Clauses 38 to 41.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”. Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.”. Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.”. As such, no claim element is to be construed as a means plus function unless the element is expressly recited using the phrase “means for.”.

1-39. (canceled)

40. An apparatus for wireless communication at a user equipment (UE), the apparatus comprising:
a transceiver;
at least one processor; and
a memory, coupled to the at least one processor and the transceiver, storing computer executable code, which when executed by the at least one processor, causes the apparatus to:
obtain first data for a first uplink channel transmission via a first uplink resource;
obtain second data for a second uplink channel transmission via a second uplink resource overlapping the first uplink resource; and
drop one of the first uplink channel transmission or the second uplink channel transmission based at least in part on the second uplink resource overlapping the first uplink resource.

41. The apparatus of claim 40, wherein at least one of the first uplink channel transmission or the second uplink channel transmission is configured for repetition.

42. The apparatus of claim 41, wherein one or more of the first uplink channel transmission or the second uplink channel transmission are configured for repetition if the apparatus is configured to repeat transmission of one or more of the first uplink channel transmission of the first data or the second uplink channel transmission of the second data.

43. The apparatus of claim 41, wherein the at least one processor is further configured to cause the apparatus to drop one of the first uplink channel transmission or the second uplink channel transmission based on one or more of the first uplink channel transmission or the second uplink channel transmission being configured for repetition.

44. The apparatus of claim 40, wherein the at least one processor, being configured to cause the apparatus to drop one of the first uplink channel transmission or the second uplink channel transmission, is further configured to cause the apparatus to drop whichever of the first uplink channel transmission or the second uplink channel transmission has a lowest priority relative to the other.

45. The apparatus of claim 40, wherein the first data has a higher priority index relative to the second data.

46. A method of wireless communication at a user equipment (UE), the method comprising:
obtaining first data for a first uplink channel transmission via a first uplink resource;
obtaining second data for a second uplink channel transmission via a second uplink resource overlapping the first uplink resource; and
dropping one of the first uplink channel transmission or the second uplink channel transmission based at least in part on the second uplink resource overlapping the first uplink resource.

47. The method of claim 46, wherein at least one of the first uplink channel transmission or the second uplink channel transmission is configured for repetition.

48. The method of claim 47, wherein one or more of the first uplink channel transmission or the second uplink channel transmission are configured for repetition if the UE is configured to repeat transmission of one or more of the first uplink channel transmission of the first data or the second uplink channel transmission of the second data.

49. The method of claim 47, wherein the method further comprises dropping one of the first uplink channel transmission or the second uplink channel transmission based on one or more of the first uplink channel transmission or the second uplink channel transmission being configured for repetition.

50. The method of claim 46, wherein the method further comprises dropping whichever of the first uplink channel transmission or the second uplink channel transmission has a lowest priority relative to the other.

51. The method of claim 46, wherein the first data has a higher priority index relative to the second data.

52. A non-transitory computer-readable medium having instructions stored thereon that, when executed by a user equipment (UE), cause the UE to perform operations comprising:
obtaining first data for a first uplink channel transmission via a first uplink resource;
obtaining second data for a second uplink channel transmission via a second uplink resource overlapping the first uplink resource; and
dropping one of the first uplink channel transmission or the second uplink channel transmission based at least in part on the second uplink resource overlapping the first uplink resource.

53. The non-transitory computer-readable medium of claim 52, wherein at least one of the first uplink channel transmission or the second uplink channel transmission is configured for repetition.

54. The non-transitory computer-readable medium of claim 53, wherein one or more of the first uplink channel transmission or the second uplink channel transmission are configured for repetition if the UE is configured to repeat transmission of one or more of the first uplink channel transmission of the first data or the second uplink channel transmission of the second data.

55. The non-transitory computer-readable medium of claim 53, wherein the operations further comprise dropping one of the first uplink channel transmission or the second uplink channel transmission based on one or more of the first uplink channel transmission or the second uplink channel transmission being configured for repetition.

56. The non-transitory computer-readable medium of claim 52, wherein the operations further comprise dropping whichever of the first uplink channel transmission or the second uplink channel transmission has a lowest priority relative to the other.

57. The non-transitory computer-readable medium of claim 52, wherein the first data has a higher priority index relative to the second data.
